(19) United States
(12) Patent Application Publication
(10) Pub. No.: US 2005/0279677 A1
(43) Pub. Date: Dec. 22, 2005

(54) Buoyant water chlorinator housing

(76) Inventor: Fong-Jei Lin, Saratoga, CA (US)

Correspondence Address: Warren P. Kujawa, Unit 3833, 1770 N. Green Valley Pkwy, Henderson, NV, 89074, US

(21) Appl. No.: 10/870,128

(22) Filed: Jun. 16, 2004

(51) Int. Cl. B01D 17/12

(52) U.S. Cl. 210/96.1; 210/85; 210/121; 210/242.1; 210/198.1

(57) ABSTRACT

A buoyant water chlorinator unit has a housing with an upper surface and an apertured chamber for receiving a chlorination agent. Three separate measurement systems are carried by the housing: a water temperature system, a pH level system, and an oxidation reduction system. The housing has apertures in the upper surface which receive removable sensor electrode receptacles capable of removably receiving the sensor electrodes for storage and containing a buffer solution used for calibration and sensor electrode preservation purposes. Outwardly extending suspension elements formed in the upper region of the housing enable sensor electrodes to be suspended from the housing with their lower ends immersed in water.

### CROSS-REFERENCE TO RELATED PATENT AND APPLICATION

This invention is an improvement over the inventions disclosed and claimed in commonly-owned U.S. Pat. No. 6,238,553 issued May 29, 2001 for “Buoyant Water Chlorinator With Temperature, pH measurement, and Chlorine Concentration Displays”; commonly-owned pending U.S. patent application Ser. No. 10/792,303 filed Mar. 3, 2004 for “pH Measurement System For Buoyant Water Chlorinator”; and commonly-owned pending U.S. patent application Ser. No. 10/352,608 filed Jan. 27, 2003 for “Improved Buoyant Water Chlorinator With Range Indicators For Temperature, pH Measurement And Chlorine Concentration”, the disclosures of which are hereby incorporated by reference.

### BACKGROUND OF THE INVENTION

This invention relates generally to water chlorination units of the type used in pools and spas. More particularly, this invention relates to an improved buoyant water chlorination housing design.

Water chlorination units are known which are used to supply chlorine to water in pools for water purification. Several such units are buoyant with an inner chamber providing a containment volume for the chlorination material, typically one or more solid pellets, with the containment volume having openings through the walls thereof so that the chlorination material can dissolve in the surrounding water.

The buoyant water chlorinator disclosed and claimed in the referenced U.S. Pat. No. 6,238,553 and pending U.S. patent applications comprises a buoyant housing with a lower apertured chamber for holding chlorine material, such as solid tablets. A removable cover retains the chlorine material in place. A plurality of measurement systems, each microprocessor-based, is carried by the housing. Each system has an easily-readable display, preferably mounted on the periphery of an upper housing surface, each display preferably comprising a liquid crystal display (LCD). One measurement system comprises a temperature sensor, such as a thermistor, for measuring the temperature of the ambient water. Electrical temperature signals produced by this sensor are coupled to a microprocessor programmed to convert these signals to signals capable of driving the associated display. A second measurement system comprises a pH level sensor for measuring the pH level of the ambient water. Electrical signals produced by this sensor are coupled to a microprocessor programmed to convert these signals to signals capable of driving the associated display. The remaining measurement system comprises an oxidation reduction potential sensor in the form of a chlorine concentration sensor for measuring the chlorine concentration of the ambient water. Electrical signals produced by this sensor are coupled to a microprocessor programmed to convert these signals to signals capable of driving the associated display. Range indicators provide a quick view of the status of each measured parameter.

Electrical power is supplied to each measurement system from a power source contained within the housing. One suitable power source is a solar cell battery mounted on the same surface as the displays. Another source is a battery installed in a battery compartment. Both types of power source may be included and either source may serve as the primary power source for all systems, with the remaining source reserved as a back-up source, or the two sources may both serve as primary sources for different systems.

The invention is generally used by placing it in the body of water in a pool or spa and observing the display values at intervals chosen by the user. When the displays indicate that the pH or chlorine concentration values need to be adjusted and that chlorine material must be added to the chlorine chamber, the cover is removed, and the fresh material is dropped into the receptacle chamber.

In order to provide accurate signals specifying the pH level of the ambient water, the pH measurement system must be initially calibrated, and the calibration should preferably be checked each time before taking a measurement. Initial calibration is done at the factory. In situ calibration is done by the user. More specifically, for in situ calibration the user initially immerses the pH sensor electrode in a buffer solution of known pH value-preferably 7.5 (the mid-range value for swimming pools and spas)-and operates a calibrate switch. Operation of the calibrate switch starts a calibration program routine in the pH microprocessor which provides an initial delay period before measuring the value of the voltage output from the pH measurement circuit. After the delay period, the microprocessor measures the output voltage, and causes the associated display to display the corresponding pH value. The user then observes this value on the display. If the displayed pH value matches the known value of the buffer solution (7.5), the unit is ready for a water sample measurement. If the display is incorrect, the user repeats the calibration process until the correct pH calibration value is displayed.

After the automatic calibration procedure is successfully completed, a water sample measurement is obtained by the user by immersing the pH sensor in the water immediately adjacent the chlorinator unit and operating a start switch. Operation of the start switch starts a sample measurement program routine in the pH microprocessor which provides an initial delay period before measuring the value of the voltage output from pH measurement circuit. After the delay period, the microprocessor measures the output voltage, and causes the associated display to display the corresponding pH value. The user then observes this value on the display. If this value lies within the acceptable range (7.4 to 7.6 in the preferred embodiment) nothing further need be done. If this measured value lies outside the acceptable range, the user then can take corrective action, usually by adding more chlorine pellets to the chlorinator unit.

While the above-described chlorinator unit is convenient to use and provides accurate readings of the water temperature, pH level and oxidation reduction potential (ORP), the need for a buffer solution during the pH in situ calibration process makes the calibration step somewhat inconvenient for the user. In particular, the user must first provide a buffer solution in a separate container, insert the pH electrode into the buffer solution in the separate container, and then wait until the pH measurement system equilibrates and an accurate calibration reading is obtained before withdrawing the pH electrode from the buffer solution and proceeding to obtain a water sample pH reading. The container for the buffer solution must then be stored in some location separate from the chlorinator unit until needed for a subsequent calibration routine. This is inconvenient for the user.

Another inconvenience with the known chlorinator unit is the need for care in handling and transporting the unit to and from the pool or spa due to the pH and ORP sensor electrodes, which must be free for immersion in the water adjacent the chlorinator housing but which are connected to the electrical circuits inside the chlorinator unit by means of flexible conductors which should not be overstressed. Also, the pH electrode must be sufficiently maneuverable to permit immersion in the buffer solution in the separate container and also immersion in the ambient water. Further, both the pH and the ORP electrodes should ideally be normally immersed in a buffer solution at all times other than a water measurement period in order to optimize their measurement capabilities.

### SUMMARY OF THE INVENTION

The invention comprises an improved water chlorinator housing which eliminates the inconveniences noted above and which provides buffer solution receptacles and sensor electrode suspension elements for facilitating handling of the chlorinator unit, in situ pH calibration, suspension of the pH and ORP electrodes in ambient water for water measurement purposes, and for maintaining both the pH and ORP electrodes suspended in a buffer solution when not otherwise in use.

In a most comprehensive aspect, the invention comprises a buoyant water conditioner with a buoyant housing having an upper region with at least one aperture, a side wall surface, and an apertured chamber for receiving a chlorination agent; and a plurality of measurement systems carried by the housing. At least one of the measurement systems has a sensor electrode for generating signals representative of a water parameter, such as pH or ORP value, when immersed in water, a display for displaying the value of that parameter, and a processor coupled to the sensor electrode and the display for converting the sensor signals to display driving signals. A source of electrical power provides power to the measurement systems.

At least one receptacle is provided which is capable of removably receiving the sensor electrode, the receptacle being removably receivable in the aperture in the housing upper region. The receptacle is also capable of holding a buffer solution.

The housing also has a suspension element extending laterally thereof for removably receiving the sensor electrode so that the lower end of the sensor electrode is immersed in water when the sensor electrode is received in the suspension element and the housing is floating in water.

In the preferred embodiment, two of the measurement systems each has a sensor electrode, the housing has two apertures formed in the upper region, two receptacles are included, and two suspension elements are provided located on opposite sides of the housing.

The invention further includes a removable cover for the housing.

In use, each sensor electrode is inserted in a corresponding receptacle containing a buffer solution, and each receptacle is installed in an upper housing aperture. If the unit is to be stored, the cover can be installed and the unit placed in storage. If the unit is to be floated on the surface of the water, the cover may be optionally installed or left off. When measurements are to be taken, the cover is removed and each sensor electrode is removed from its receptacle and installed in an associated one of the suspension elements so that the lower end of each sensor electrode is immersed in the water to be tested. After measurements have been made, the unit may be left in the water or removed for storage elsewhere. It is preferable that each sensor electrode be removed from the suspension element and placed in a receptacle after measurements are taken so that the lower end of a sensor electrode is immersed in the buffer solution when not used for measurement purposes.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a schematic perspective view of the preferred embodiment of the invention;

FIG. 2 is a top plan view of the invention of FIG. 1;

FIG. 3 is a view similar to FIG. 1 showing one of two sensor electrodes and receptacles removed from the main housing and the second sensor electrode installed in a suspension element;

FIG. 4 is a side elevation showing a sensor electrode inserted in a receptacle;

FIG. 5 is a perspective view showing a sensor electrode and a receptacle; and

FIG. 6 is a side elevation showing the invention floating in water with both sensor electrodes deployed in the suspension elements.

### DETAILED DESCRIPTION OF THE PREFERRED EMBODIMENT

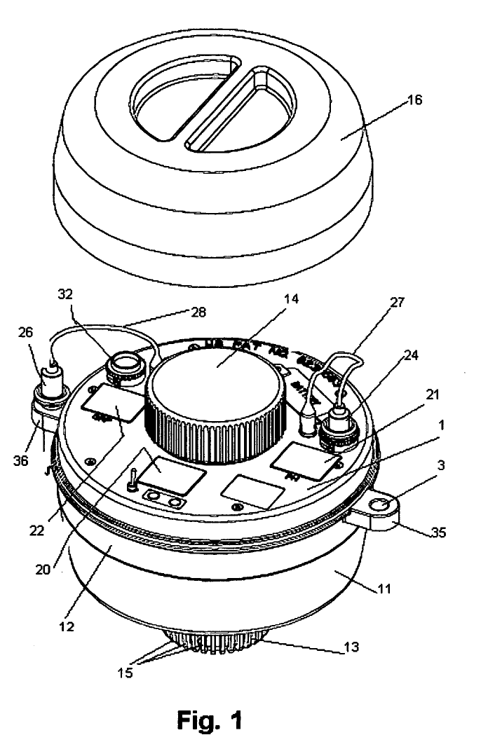

Turning now to the drawings, FIG. 1 is a schematic view illustrating the preferred embodiment of the invention. As seen in this FIG., the preferred embodiment includes a housing 11, typically made from plastic material. Housing 11 has an upper sealed hollow space 12 to ensure buoyancy in water, and a lower wall portion 13 providing a hollow interior for receiving one or more water-soluble chlorine tablets (not shown). A chlorine chamber cover 14 is removably mounted in the central region of the top of housing 11 to provide access to the hollow interior. A plurality of openings 15 are distributed about the circumference of lower wall portion 13 to allow water to enter the hollow interior volume and leach chlorine from the tablets. A protective cover 16 is removably mounted to the top of housing 11. To add more chlorine tablets, covers 16 are 14 are sequentially removed to expose the hollow lower interior.

Arranged about the upper peripheral surface 17 of housing 11 are three liquid crystal (LCD) displays 20-22. Display 20 is a water temperature display; display 21 is a pH level display; and display 22 is an oxidation reduction (ORP) display. Each display 20-22 is driven by an electronic circuit contained within housing 11. The electronic circuit used to drive pH level display 21 receives electrical signals from a pH sensor electrode 24. Similarly, the electronic circuit used to drive ORP display 22 receives electrical signals from an ORP sensor electrode 26. Sensor electrodes 24, 26 are connected to their associated electronic circuits by flexible conductor cables 27, 28.

Electrical power is supplied to the displays 20-22 and corresponding circuits by batteries mounted within housing 11 below removable cover plates 29, 30.

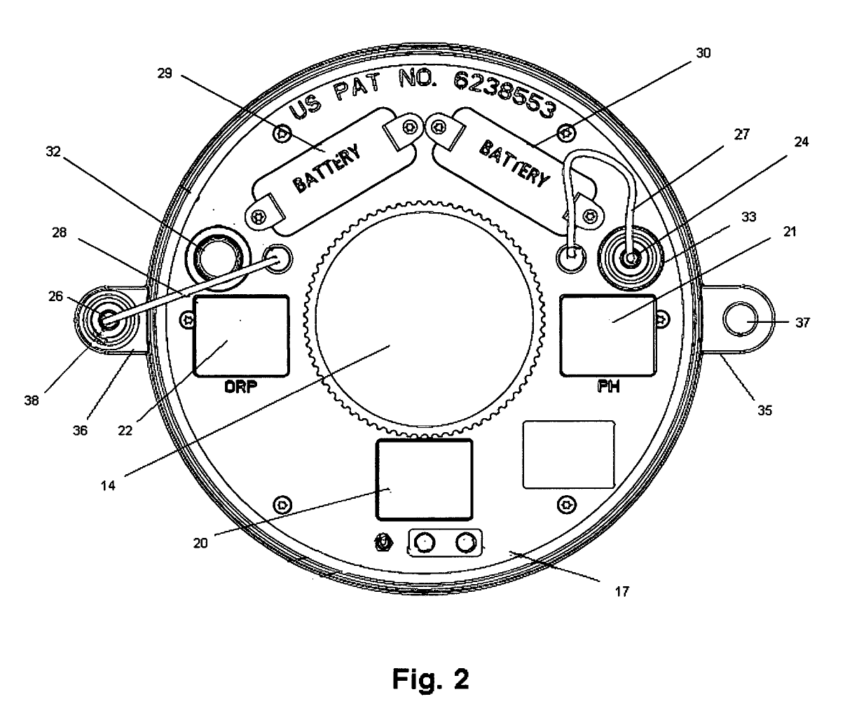

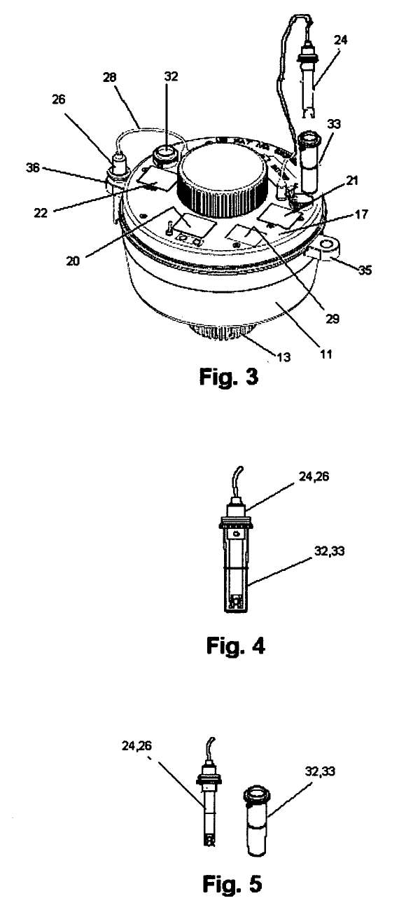

With reference to FIGS. 1-3, the upper surface 17 of housing 11 is provided with a pair of apertures for removably receiving a pair of removable sensor electrode receptacles 32, 33. As best seen in FIGS. 4 and 5, each receptacle 32, 33 has an essentially cylindrical body portion, which may be slightly tapered from top to bottom, a hollow interior with a closed bottom for removably receiving an associated sensor electrode 24, 26, and an upper collar portion for providing a limit stop when the receptacle is inserted in the corresponding aperture in upper surface 17 of housing 11. Receptacles 32, 33 may also include a locking member, such as a locking lug or threaded member to enable positive engagement of the receptacle in the aperture in upper surface 17 of housing 11.

As also seen in FIGS. 4 and 5, each sensor electrode 24, 26 has an essentially cylindrical main body portion, and an upper collar portion for providing a limit stop when the electrode is inserted in the corresponding receptacle 32, 33. As with receptacles 32, 33, sensor electrodes 24, 26 may also include a locking member, such as a locking lug or threaded member, to enable positive engagement of the sensor electrode in the associated receptacle 32, 33.

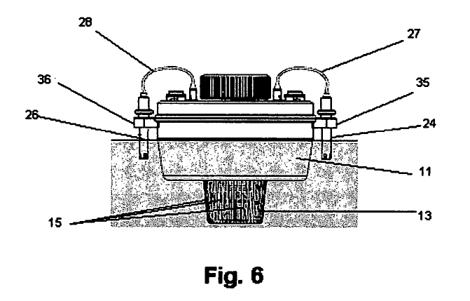

Extending outwardly from the upper region of the outer surface of housing 11 is a pair of sensor electrode suspension elements 35, 36. Each suspension element 35, 36 has a central aperture 37, 38 sized to receive the sensor electrodes 24, 26. As best seen in FIG. 6, when the sensor electrodes 24, 26 are mounted in the associated suspension element 35, 36, the lower end of each electrode 24, 26 is immersed in the ambient water below the water line 38.

In use, with cover 16 removed a buffer solution of proper pH value (7.5 in the preferred embodiment) is initially placed into the interior of each receptacle 32, 33. Sensor electrodes 24, 26 are then inserted into the associated receptacle 32, 33 so that the lower end of each sensor electrode in immersed in the buffer solution. Cover 16 may then be replaced and the chlorinator unit can be transported to a desired location, such as a storage area or the pool or spa. Calibration can be performed at any time by manipulating the proper switches and observing the pH value with cover 16 removed. To perform a pH or ORP measurement, sensor electrodes 24, 26 are removed from the receptacles 32, 33 and inserted into the suspension elements 35, 36, and the start switch is operated by the user. The results are observed on the displays 20-22 by the user. To withdraw the chlorinator unit from service, the sensor electrodes 24, 26 are removed from the suspension elements 35, 36 and inserted into the receptacles 32, 33, and cover 16 is installed on housing 11.

As will now be apparent, the invention provides all of the advantages of the invention disclosed in the above-referenced U.S. patent and patent application, and in addition provides ease and convenience in handling, transporting, storing, calibrating, and measuring with the chlorination unit. The provision of the receptacles 32, 33 provides convenient storage for the sensor electrodes 24, 26 when not used for measurement, and facilitates the calibration of the pH sensor circuit. In addition, containment of the sensor electrodes in the buffer solution held by the receptacles 32, 33 promotes long life and continued accuracy for the sensor electrodes 24, 26. In addition, the suspension elements 35, 36 provide a convenient mechanism for holding the sensor electrodes with the lower ends immersed in the water and add little cost to the housing (since they can be an integrally molded extension of the housing).

Although the above provides a full and complete disclosure of the preferred embodiments of the invention, various modifications, alternate constructions and equivalents will occur to those skilled in the art. For example, although the invention has been described with reference to essentially cylindrical receptacles 32, 33 and sensor electrodes 24, 26, other geometrical configurations may be used. In addition, although the preferred embodiment uses two sets of sensor electrodes, receptacles and suspension elements, other numbers of such sets may be employed. Also, although the receptacle apertures are shown and described as being formed in the upper surface of the housing, other arrangements are possible such as outboard of the housing outer wall surface or inboard in the chlorine pellet aperture region. Therefore, the above should not be construed as limiting the invention, which is defined by the appended claims.

1. A buoyant water conditioner comprising:
a buoyant housing having an upper region with at least one aperture, a side wall surface, and an apertured chamber for receiving a chlorination agent;
a plurality of measurement systems carried by said housing, at least one of said systems having a sensor electrode for generating signals representative of a water parameter when immersed in water, a display for displaying the value of that parameter, and a processor coupled to said sensor and said display for converting the sensor signals to display driving signals;
a source of electrical power for providing power to said systems; and
at least one receptacle for removably receiving said at least one sensor electrode, said receptacle being removably receivable in said at least one aperture in said housing upper region,
said housing having at least one suspension element extending laterally thereof for removably receiving said at least one sensor electrode so that the lower end of said at least one sensor electrode is immersed in water when said at least one sensor electrode is received in said at least one suspension element and said housing is floating in water.

2. The invention of claim 1 wherein one of said measurement systems comprises a pH level measurement system.

3. The invention of claim 1 wherein one of said measurement systems comprises an ORP measurement system.

4. The invention of claim 1 wherein two of said measurement systems each has a sensor electrode, said housing has two apertures formed in said upper region , two receptacles are included, and two suspension elements are provided.

5. The invention of claim 1 wherein said two suspension elements are located on opposite sides of said housing.

6. The invention of claim 1 wherein said housing has an upper surface and said at least one aperture is formed in said upper surface.

7. The invention of claim 1 further including a removable cover for said housing.

8. A buoyant housing for a water conditioner unit having a measurement system with a sensor electrode, said housing having an upper region with an aperture for receiving a sensor receptacle, a side wall surface, an apertured chamber for receiving a chlorination agent, and at least one suspension element extending laterally thereof for removably receiving a water conditioner sensor electrode so that the lower end of the sensor electrode is immersed in water when the sensor electrode is received in the suspension element and said housing is floating in water.

9. The invention of claim 8 wherein said housing has an upper surface and said aperture is formed in said upper surface.

10. The invention of claim 8 wherein said housing has a pair of apertures located in said upper region, each aperture being arranged to receive a sensor receptacle; and wherein said housing has a pair of suspension elements extending laterally therefrom at different locations for removably receiving a pair of water conditioner sensor electrodes.

11. The invention of claim 8 further including a removable cover for said housing.
